(19) United States
(12) Patent Application Publication
(10) Pub. No.: US 2023/0079800 A1
(43) Pub. Date: Mar. 16, 2023

(54) ADJUSTABLE HITCH

(71) Applicant: RIHA Industries Pty Ltd, Edinburgh (AU)

(72) Inventor: Nicolas RITTER, Edinburgh (AU)

(73) Assignee: RIHA Industries Pty Ltd, Edinburgh (AU)

(21) Appl. No.: 17/895,494

(22) Filed: Aug. 25, 2022

(30) Foreign Application Priority Data
Sep. 14, 2021 (AU) 2021232685

(51) Int. Cl. B60D 1/46; B60D 1/04

(52) U.S. Cl. CPC B60D 1/465; B60D 1/04; B60D 2001/005

(57) ABSTRACT

An adjustable hitch mounted on a self-driving machine and providing a coupling to a trolley. The hitch includes generally two gas struts connected to two parallel arms to bias the hitch in an upward direction pivoting with respect to the driving machine. This enables the hitch to be moved in a vertical direction to facilitate it connecting with the trolley, typically the frame of the trolley, to allow for the hitch to be lowered to engage a frame of the trolley. An engagement assembly, being connected to the lifting arm, wherein it has a face and a jaw that are configured to securely engage with the wheeled equipment.

### FIELD OF THE INVENTION

The present disclosure generally relates to an adjustable hitch, especially to a hitch adapted to provide a connection with a driving means and a load to be moved.

### BACKGROUND OF THE INVENTION

Due to various safety and health issues, it has become common to use an apparatus that is self-driving and that can be used to pull or push a load. This is especially so inside of buildings, such as hospitals or warehouses, where a self-driving apparatus typically engages a trolley. Such trolleys may be used to move items such as prepared meals, linen, or spare parts to name but a few

Given that there are numerous configurations of self-driving apparatuses and trolleys the mechanical coupling between the two is not always possible without having to retrofit hitches to engage the trolley or provide strap connections coupling the two. In addition, the frames of the trolleys may be of different cross-sectional sizes that need to be engaged by the self-driving apparatus.

There are various hospital bed movers that could be connected to a range of trolleys. Because of the nature of their design, these machines push the trolleys rather than pulling them. This is in a hospital environment classed as a risk since the objects which have to be moved are up to 1.8 metres high and the operator may find it difficult to see past the object. There is also the issue that the connection between these kind of machines and the heavy wheeled objects are fixed, meaning there is no rotational link which makes it difficult to get around tight corners.

The self-driving apparatus may allow the user to stand or sit in it whilst pulling equipment such as a trolley. Once again none of these apparatuses provide for the ability to engage different trolley configurations, especially where the bottom frame of the trolleys that need to be engaged may be at different heights and sizes.

Thus, there is a need for an apparatus to assist in the movement of wheeled objects with a motorised machine that is capable of engaging the object securely and that provides an adjustable attachment hitch that accommodates different size trolleys with a different wheel profiles.

It is desired to address or ameliorate one or more disadvantages or limitations associated with the prior art, or to at least provide a useful alternative.

### SUMMARY OF THE INVENTION

In a first form of the invention there is proposed an adjustable hitch for use with wheeled equipment, comprising:

a machine mounting assembly attached to a motorised machine;
a lifting assembly, being adjustably connected to the machine mounting assembly, including at least one gas strut connected to at least one lifting arm the gas strut biased to push the lifting arm up; and
an engagement assembly, being connected to the lifting arm, wherein it has a face and a jaw that are configured to securely engage with the wheeled equipment.

In preference the width between the face and jaw flap can be adjusted which allows a connection to wheeled equipment with different size frames or tubes.

In preference the jaw connects to the face via two bolts.

In preference there are two lifting arms which allow the face to always be approximately 90 degree to the horizontal plane of the machine.

In preference the hitch further comprises at least two brackets connected via the lifting arms to the face and jaw.

In preference the hitch further comprises nylon bushes which are fitted to the two rotating brackets and connected via a pin.

### BRIEF DESCRIPTION OF THE DRAWINGS

Some embodiments of the present invention are hereinafter further described, by way of example only, with reference to the accompanying drawings, in which:

FIG. 1 is an elevation of an adjustable hitch according to a preferred embodiment of the present invention;

FIG. 2 is a three-dimensional view of the adjustable hitch according to the preferred embodiment of the present invention;

FIG. 3 is a three-dimensional exploded view of the adjustable hitch in FIG. 2; and

FIG. 4 is a three-dimensional view of a motorised machine with the adjustable attachment hitch according to the preferred embodiment of the present invention.

### DETAILED DESCRIPTION OF THE INVENTION

The following detailed description of the invention refers to the accompanying drawings. Wherever possible, the same reference numbers will be used throughout the drawings and the following description to refer to the same and like parts. Dimensions of certain parts shown in the drawings may have been modified and/or exaggerated for the purposes of clarity or illustration.

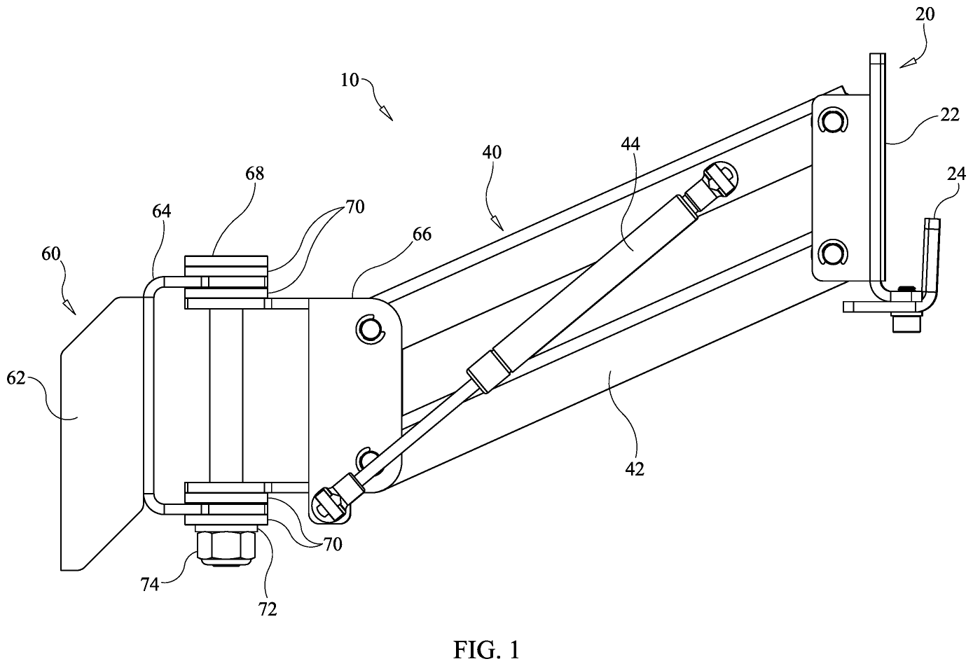

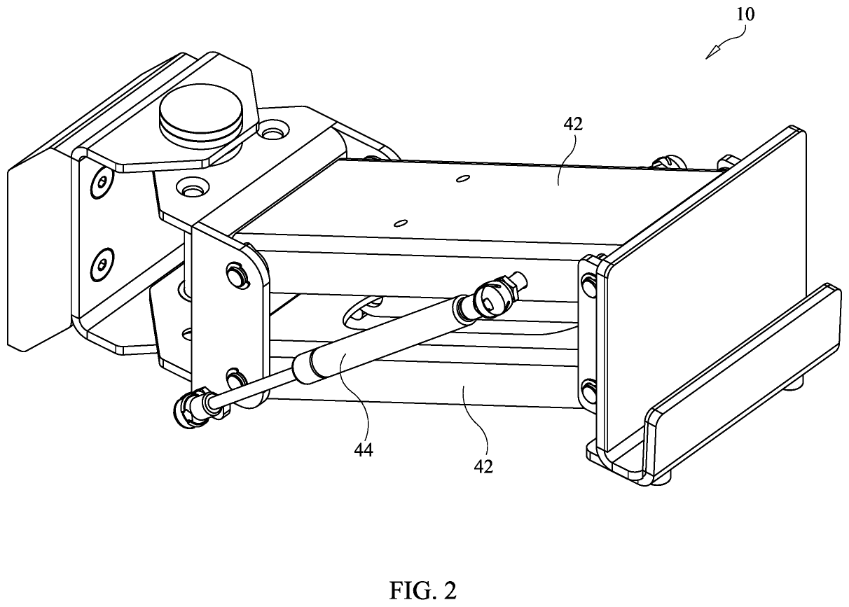

Referring to FIGS. 1-4, an adjustable hitch 10 for connecting a self-driving machine and a wheeled apparatus, such as a trolley, comprises a machine mounting assembly 60, a lifting assembly 40 and an engagement assembly 20. The machine mounting assembly 60 is attached to a motorised machine 80 which will be described in detail later.

The lifting assembly 40 is adjustably connected to the machine mounting assembly 60. It includes at least one gas strut 44 connected to at least one lifting arm 43. The gas strut 44 is configured to push the lifting arm 43 up. Typically, there are two parallel lifting arms 42 and 43 and two gas struts each on the opposite sides of the lifting arms.

Instead of a gas struts other biased means may be used, such as spring-loaded arms.

The engagement assembly 20 is connected to the lifting arms 42 and 43. The engagement assembly 20 has a face 22 and a jaw 24 that are configured to engage with the wheeled equipment, typically by engaging a bottom frame.

Now turning to the motorised machine 80, it consists of a 5 mm thick metal frame. Two electric motors, typically operating at 24V, are fitted on either side towards the rear of the machine. Generally, 6×12V 20 Amp deep cycle gel batteries are located between the motors. The motors and batteries are connected to a module which is located at the front, LH side on top of the batteries and underneath a handle column. A controller is fitted to the top of the handle column and is connected via a bus cable to the module. The controller is equipped with a joystick that controls the movement as well as the speed of the machine. At the same time Bluetooth capabilities of the controller allow the operator to connect their mobile device such as a phone to access statistics as well as diagnostic information. An external battery charger can be connected to the controller and charges all 6 batteries. Two spring loaded castors at the front on each side are responsible for the smooth movement of the machine.

Specifically, the hitch 10 provided by the preferred embodiment attaches to the rear of the motorised machine 80 through the mounting assembly 60. It further comprises a machine mounting plate 62 and at least two brackets 64, 66 that connect via two lifting arms 42 to the lifting face 22 and the jaw 24. Bracket 66 rotates with respect to bracket 64 allowing the hitch to be rotated in the horizontal plane. Lifting arms 42 and 43 can pivot in the vertical direction such that the engagement assembly 20 can be adjusted vertically. through the lifting arms 42. The hitch 10 further comprises several nylon bushes 70 which are fitted to the two brackets 64, 66 and connected via a pin 68 in the cooperation with a washer 72 and a nylon nut 74.

The two lifting arms 42, 43 allow the lifting face 22 to extend horizontally in line with the motorised machine in a first position and then move vertically to engage the frame of the trolley. It means when the motorised machine is to engage the trolley, the engagement assembly 20 can be lowered down while the lifting face 22 keeps vertically in relative the bottom of the motorised machine. As such, the lifting arms 42, 43 greatly facilitate the engagement procedure since it allows the engagement assembly 20 to rotate horizontally and vertically.

The jaw 24 connects to the face 22 via two bolts 26. In particular, the width between the face 22 and jaw can be adjusted which allows a tight engagement of the machine to the trolley that may have different size frame components. Therefore, the adjustable hitch 10 provided by the preferred embodiment not only increases the flexibility of the attachment of the wheel equipment to the motorised machine but also suits wheel equipment with different types and sizes.

The face includes a plate 52, typically made of polyurethane that provides a better grip of the trolley and prevents scratches. Other material may be used that possess the same properties.

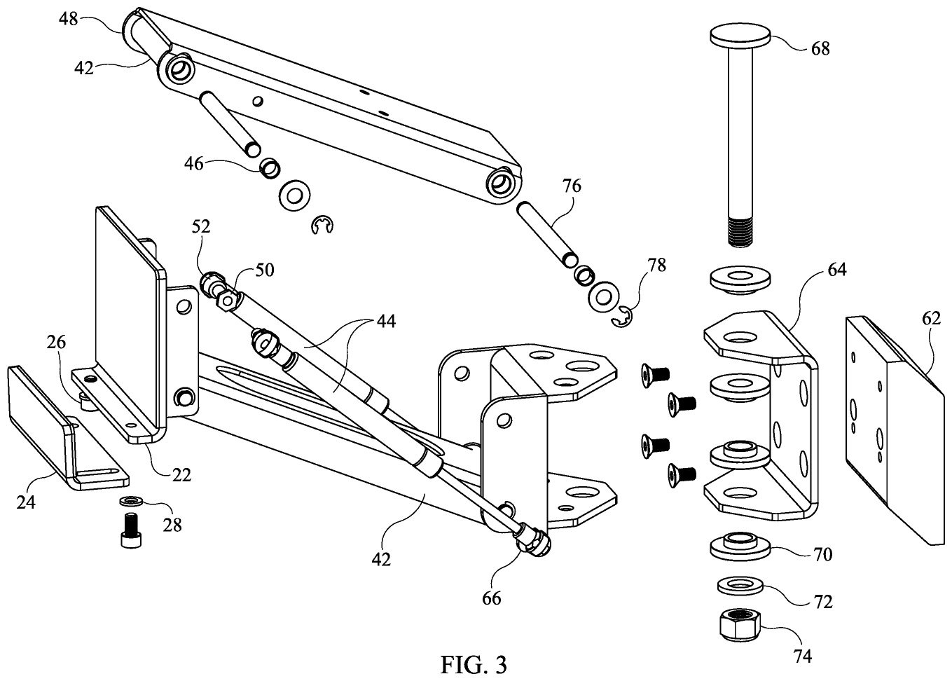

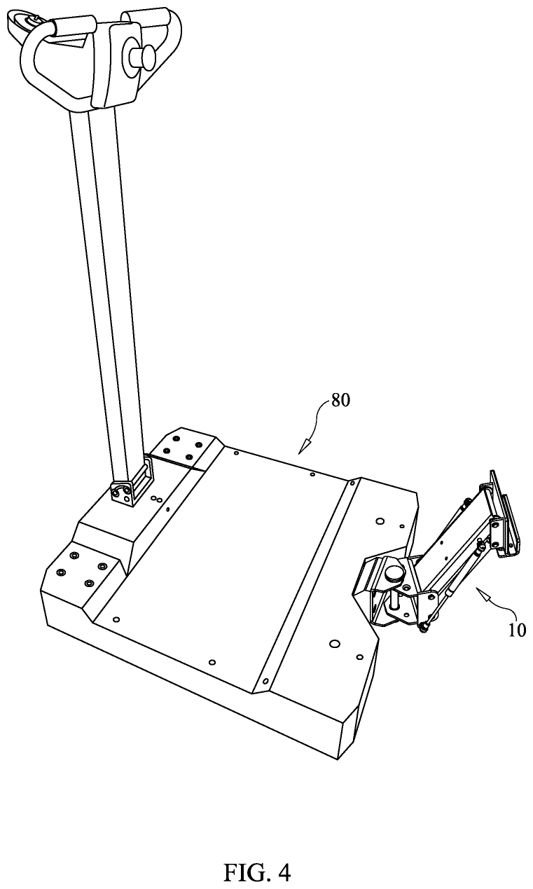

Referring to an example of the present invention as shown in FIG. 3, the adjustable hitch 10 attaches to the rear of the motorised machine as shown in FIG. 4. It consists of two rotating brackets, nylon bushes, lifting arms, face, jaw and gas struts. The nylon bushes are fitted to the rotating brackets and connected via a pin. These two brackets connect via the lifting arms to the face and jaw. Using two lifting arms allows the lifting face to always extend vertically, or at a pre-set angle. Two gas struts bias the arms up. The operator is able to push the arms down to the ground using their foot in order to slide the jaw under the trolley and release it so that the jaw moves up to engage the trolley, typically a cross-member of the trolley frame. Of course, other means may be employed to move the jaw, such as motorised means as would be obvious to the person skilled in the art.

Using the gas struts allows a connection to trolleys with different heights. The jaw connects to the face via two bolts. The width between the face and jaw flap can be adjusted which allows a secure connection to trolleys with different size frames or tubes.

The combination of the motorised machine together with the adjustable hitch allows transportation over a longer distance as well as ramp operations and reduces walking distance of staff. The adjustable hitch that can be pushed down to ground levels allows a connection with low profile trolleys. Existing solutions do not offer this kind of flexibility. The rotating mechanism of the hitch also improves maneuverability around tight corners.

### LIST OF COMPONENTS

The drawings include the following integers:
10 hitch
20 engagement assembly
22 face
24 jaw
26 bolts
28 washer
40 lifting assembly
42 lifting arm
43 lifting arm
44 gas strut
46 bushes
48 washer
50 nut
52 plate
60 mounting assembly
62 machine mounting plate
64,66 rotating brackets
68 pin
70 nylon bushes
72 washer
74 nylon nut
76 arm pin
78 circlip
80 motorised machine

References in this specification to any prior publication (or information derived from it), or to any matter which is known, is not and should not be taken as acknowledgment, admission, or any form of suggestion that that prior publication (or information derived from it) or known matter forms part of the common general knowledge in the field of endeavour to which this specification relates.

Further advantages and improvements may very well be made to the present invention without deviating from its scope. Although the invention has been shown and described in what is conceived to be the most practical and preferred embodiment, it is recognised that departures may be made therefrom within the scope of the invention, which is not to be limited to the details disclosed herein but is to be accorded the full scope of the claims to embrace any and all equivalent devices and apparatus. Any discussion of the prior art throughout the specification should in no way be considered as an admission that such prior art is widely known or forms part of the common general knowledge in this field.

In the present specification and claims, the word “comprising” and its derivatives including “comprises” and “comprise” include each of the stated integers but does not exclude the inclusion of one or more further integers.

1. An adjustable hitch for use with a wheeled equipment, comprising:
a machine mounting assembly attached to a motorised machine;
a lifting assembly, being adjustably connected to the machine mounting assembly, including at least one gas strut connected to at least one lifting arm the gas strut biased to push the lifting arm up; and
an engagement assembly, being connected to the lifting arm, wherein it has a face and a jaw that are configured to securely engage with the wheeled equipment.

2. The hitch of claim 1, wherein the width between the face and jaw flap can be adjusted which allows a connection to wheeled equipment with different size frames or tubes.

3. The hitch of claim 2, wherein the jaw connects to the face via two bolts.

4. The hitch of claim 1, wherein there are two lifting arms which allow the face to always be approximately 90 degree to the horizontal plane of the machine.

5. The hitch of claim 1, wherein the hitch further comprises at least two brackets connected via the lifting arms to the face and jaw.

6. The hitch of claim 5, wherein the hitch further comprises nylon bushes which are fitted to the two rotating brackets and connected via a pin.
